(19) United States
(12) Patent Application Publication
(10) Pub. No.: US 2016/0320242 A1
(43) Pub. Date: Nov. 3, 2016

(54) TEMPERATURE PROBE THERMOWELL ASSEMBLY

(71) Applicant: United States ThermoAmp Inc., Latrobe, PA (US)

(72) Inventor: William P. Bernardi, Ligonier Township, PA (US)

(21) Appl. No.: 15/140,581

(22) Filed: Apr. 28, 2016

Related U.S. Application Data
(60) Provisional application No. 62/154,162, filed on Apr. 29, 2015.

(51) Int. Cl. G01K 1/08; G01K 13/02; G01K 7/22; G01K 1/14

(52) U.S. Cl. CPC G01K 1/08; G01K 1/14; G01K 13/02; G01K 7/22

(57) ABSTRACT

A temperature probe assembly includes an internal fitting having an exterior and a hollow interior; a temperature sensor disposed within the hollow interior of the internal fitting, the temperature sensor being configured to be placed in communication with an external controller; an external fitting disposed on the exterior of the internal fitting; and a tube connected to the external fitting. The temperature probe assembly is configured to be inserted into a thermowell. The tube and external fitting are configured to house and support the internal fitting in the thermowell.

### CROSS REFERENCE TO RELATED APPLICATION

The present application claims priority from U.S. Provisional Patent Application No. 62/154,162, filed on Apr. 29, 2015, which is incorporated herein by reference in its entirety.

### BACKGROUND OF THE INVENTION

1. Field of the Invention

The present disclosure relates generally to fluid heating and/or cooling devices, such as air-source heat pumps, that use an electronic temperature probe in conjunction with a thermowell, and, in particular, to an improved thermowell assembly for a slide-in electronic temperature probe.

2. Description of Related Art

Heat pumps are increasingly replacing fossil fuel heaters, especially in applications where using a heat pump is a more cost-effective heating method. Air-source heat pumps have been used in various applications to transfer heat from outdoor air into another fluid or heat sink. Applications for such heat pumps include space and water heating, as well as providing process heat for industrial and commercial applications, such as agricultural aquariums, fish ponds, and swimming pools.

In order to maintain the fluid temperature at a desired temperature, all fluid heaters and coolers generally have a thermostat to set and monitor fluid temperature and a controller to turn the fluid heater and/or cooler on and off based on the fluid temperature. In most instances, the thermostat is in the form of a thermostat bulb or probe. A sealed tube or thermostat well, commonly known as thermowell, is used to house the thermostat bulb or probe before placing the assembly into the fluid. By isolating the thermostat probe from the fluid, the thermowell provides thermal contact with the fluid while protecting the thermostat probe from corrosion, electrical shorting, and other damage that may be caused by the fluid. Thermowell also eliminates the need to seal the thermostat probe.

Thermowells are commonly formed as short tubes that are plugged with a caulking material, or capped and welded, or soldered shut in order to prevent leaks and to protect the probe from being corroded, shorted out, or otherwise damaged by the heated fluid. In addition, a gland is used to seal around the thermowell tube to further prevent heated fluid from leaking out of the heat exchanger while allowing the thermowell to be easily replaced. It is noted that standard tubing sizes for thermowells and sensors are not designed to fit inside each other. Rather, they are offered in a number of sizes so that manufacturers can minimize cost, accommodate flow consideration, and demand of consumers.

The most commonly used electronic water temperature sensors in heaters and coolers are standard slide-in temperature sensors. The use of a thermowell with a slide-in temperature probe is common in the swimming pool heat pump industry, as well as other fluid heating device industries. The slide-in temperature sensor is typically inserted into the thermowell. Slide-in temperature sensors are usually made of a small bead-type thermistor with relatively fast response time. The thermistor is further embedded in epoxy potting compound, which seals the thermistor and a cable that is connected to the thermistor. The sensor housing usually has a short piece of metal or plastic tube. In most instances, the sensor assembly is potted in a short piece of tubing cut from readily available standard size thermowell tubing so that the materials of two tubing pieces match. Matching the tubing materials eliminates galvanic corrosion between the thermowell and the sensor and reduces the cost of manufacturing. The size of the sensor assembly tube is usually one size smaller than the size of thermowell tube. The most common size of thermowell tube has a standard ½″ outside diameter. Although thin wall tubing is readily available and economical, the wall thickness varies considerably based on the manufacturer's choice of tube material and supplier. Wall thicknesses can range from 0.020″ to 0.064″, which are not uncommon for a standard ½″ tube.

With reference to FIG. 1, a typical air-source heat pump for swimming pool applications is shown. Cool water is pumped in through a pump P, filtered through a pool filter, and heated through a heat pump. Using commonly-known vapor-compression cycle heat pump components, the swimming pool heat pump in FIG. 1 transfers the heat from the refrigerant circulating in a helical coil to the swimming pool water. In order to monitor the water temperature, a slide-in temperature sensor is used. The slide-in temperature sensor is further connected to a microprocessor controller. The microprocessor controller turns the heat pump on and off based on the temperature sensed and the thermostat set point.

With reference to FIG. 2, the slide-in temperature sensor is shown in detail. A capped and sealed thermowell 1 houses the slide-in thermistor sensor 2. The slide-in thermistor sensor 2 contains a thermistor to sense the water temperature, generate temperature signals, and send temperature signals through a cable 3 to the microprocessor controller.

The advantages of using slide-in temperature sensors include easy replacement, low cost, and ease of manufacture. However, there are disadvantages associated with using slide-in temperature sensors that cannot be overlooked. During operation, slide-in temperature sensors may have excessive air gaps between the sensor and the thermowell. The sensor-to-thermowell tube interface must have a clearance with the thermowell tube inside diameter, which can be exaggerated by the use of standard size tubing. In most instances, it is necessary to use some type of a clip or a clamp to hold the sensor against the inside wall of the thermowell in order to maintain thermal contact.

In addition, most slide-in temperature sensors create a high thermal mass because its housing tube must be filled and sealed with epoxy. These sensors can only sense the temperature from the wall of the thermowell through the side of the sensor housing, and only reach the same temperature as the heated fluid when the mass of epoxy inside, of which the thermistor is embedded, is heated to that temperature. All of these factors make it difficult to obtain a fast response time when the fluid is heating up so as not to overshoot the set temperature. When the fluid is rapidly changing temperature, the sensor temperature reading will lag behind the fluid. An accurate reading will only occur after the fluid has stopped changing temperature for a period of time that exceeds the response time of the probe. The thermal lag will result in inaccurate temperature readings and cycling of the heating or cooling device.

### SUMMARY OF THE INVENTION

Generally, provided is a temperature probe thermowell assembly that minimizes thermal lag by having a reduced thermal mass and conductivity and that is useful in connection with both new and existing heat exchange systems and arrangements. In various preferred and non-limiting embodiments, provided are different configurations of a temperature probe thermowell assembly having enhanced functionality, reduced air gaps, reduced thermal mass, reduced epoxy volume, fast response time, and/or enhanced manufacturing.

According to one non-limiting embodiment or aspect of the present disclosure, a temperature probe assembly is provided that can be used to replace a slide-in temperature sensor and thermowell with a combination probe thermowell of the same size, which is capable of using the same sealing gland and which greatly reduces response time by reducing the thermal mass of the probe assembly. The tube housing is separated from the probe to allow for the minimization of both the probe housing mass and the probe epoxy mass required to embed the thermistor by using bare wire/thermistor leads separated by very thin insulating paper to prevent shorting while allowing epoxy penetration. A snap ring, or alternatively a set of special threads, are used in combination with an O-ring sealing gland to allow for quick assembly and sealing.

According to another non-limiting embodiment or aspect of the disclosure, a three piece temperature probe assembly is provided that includes a small probe fitting that maintains the same overall diameter as a typical slide-in probe. The fitting houses the thermistor, epoxy, cabling, etc. in its interior in a manner that minimizes epoxy use and maximizes thermal exposure to the fluid. Using a very thin insulating paper, which is approximately 0.003″ thick, wrapped between and around the thermistor wire leads prior to injection of the sealing epoxy allows for minimal epoxy volume while still ensuring that no shorting or electrical conduction occurs between the wires, solder, etc. A sealing O-ring gland and a fastening feature using a snap ring or a special reduced pitch thread are provided on the exterior of the fitting to allow easy and quick assembly of the fitting to the remainder of the assembly. The assembly also includes a weld socket fitting with one end designed to be welded to the thermowell tube to seal out fluid at one end and to lock in and seal the probe fitting at the other end using either the snap ring or threaded feature and O-ring sealing gland. The assembly further includes a short piece of thin wall tubing which can be welded to the weld socket fitting.

According to another non-limiting embodiment or aspect of the disclosure, a temperature probe thermowell assembly may have an O-ring fitting having a first groove and a second groove; a socket fitting having a first notch and a second notch; an O-ring positioned between the first groove of the O-ring fitting and the first notch of the socket fitting; and a snap ring positioned between the second groove of the O-ring fitting and the second notch of the socket fitting.

According to another non-limiting embodiment or aspect of the disclosure, a temperature probe thermowell assembly may have an O-ring fitting having a first groove and a first threaded portion; a socket fitting having a first notch and a second threaded portion, wherein the second threaded portion of the socket fitting is mated with the first threaded portion of the O-ring fitting; and an O-ring, wherein the O-ring is positioned between the first groove of the O-ring fitting and the first notch of the socket fitting.

According to one preferred and non-limiting embodiment or aspect of the present disclosure, a temperature probe assembly is provided. The temperature probe assembly includes an internal fitting having an exterior and a hollow interior; a temperature sensor disposed within the hollow interior of the internal fitting, the temperature sensor being configured to be placed in communication with an external controller; an external fitting disposed on the exterior of the internal fitting; and a tube connected to the external fitting. The temperature probe assembly is configured to be inserted into a thermowell. The tube and external fitting are configured to house and support the internal fitting in the thermowell.

According to one aspect, the internal fitting is connected to the external fitting by a fastening mechanism.

According to one aspect, the fastening mechanism includes a snap-ring disposed between the internal fitting and the external fitting, the snap-ring engaging a notch defined in the exterior of the internal fitting and a corresponding groove defined on an interior surface of the external fitting.

According to one aspect, the fastening mechanism includes a threaded engagement between the internal fitting and the external fitting.

According to one aspect, the assembly further includes a sealing element disposed between the external fitting and the internal fitting and configured to at least partially seal an engagement between the internal fitting and the external fitting. The sealing element may include an O-ring disposed in a notch defined in the exterior of the internal fitting.

According to one aspect, the temperature sensor includes a thermistor disposed within the hollow interior of the internal fitting adjacent to an end of the internal fitting and at least two wires. The at least two wires connect the thermistor to a cable extending from the internal fitting, the cable being configured to place the thermistor in communication with the external controller. The at least two wires are separated from each other and the internal fitting by an insulator. The insulator may include a layer of insulative paper or tape. The layer of insulative paper or tape is wrapped around and between the at least two wires.

According to one aspect, the hollow interior of the internal fitting is filled with an epoxy material.

According to one aspect, the tube and the external fitting are connected by welding.

According to one preferred and non-limiting embodiment or aspect of the present disclosure, a method of assembling a temperature probe assembly is provided. The method includes providing an internal fitting having an exterior and a hollow interior, a temperature sensor configured to be placed in communication with an external controller, an external fitting, and a tube; assembling the temperature sensor within the hollow interior of the internal fitting; assembling the external fitting on the exterior of the internal fitting; and connecting the tube to the external fitting. The temperature probe assembly is configured to be inserted into a thermowell. The tube and external fitting are configured to house and support the internal fitting in the thermowell.

According to one aspect, the step of assembling the external fitting on the exterior of the internal fitting includes connecting the external fitting to the internal fitting with a fastening mechanism.

According to one aspect, the fastening mechanism includes a snap-ring disposed between the internal fitting and the external fitting and the connecting step includes engaging the snap-ring with a notch defined in the exterior of the internal fitting and a corresponding groove defined on an interior surface of the external fitting.

According to one aspect, the fastening mechanism includes a threaded engagement between the internal fitting and the external fitting and the connecting step includes threadably engaging the internal fitting with the external fitting.

According to one aspect, the method further includes at least partially sealing an engagement between external fitting and the internal fitting with a sealing element disposed between the external fitting and the internal fitting.

According to one aspect, the temperature sensor includes a thermistor and at least two wires. The step of assembling the temperature sensor within the hollow interior of the internal fitting includes disposing the thermistor in the hollow interior of the internal fitting adjacent to an end of the internal fitting; connecting the at least two wires to a cable extending from the internal fitting, the cable being configured to place the temperature sensor in communication with the external controller; and separating the at least two wires from each other and the internal fitting with an insulator. The insulator includes a layer of insulative paper or tape and the step of separating the at least two wires includes wrapping the insulative paper or tape around and between the at least two wires.

According to one aspect, the method further includes filling the hollow interior of the internal fitting with an epoxy material.

According to one preferred and non-limiting embodiment or aspect of the present disclosure, a method of assembling a temperature probe assembly in a thermowell is provided. The method includes providing the temperature probe assembly. The temperature probe assembly includes an internal fitting having an exterior and a hollow interior; a temperature sensor disposed within the hollow interior of the internal fitting; an external fitting disposed on the exterior of the internal fitting; and a tube connected to the external fitting. The method further includes inserting the temperature probe assembly into a thermowell to position the temperature probe assembly in the thermowell to measure a temperature of a fluid in a container in which the thermowell is defined; and placing the temperature sensor in communication with an external controller. The tube and external fitting of the temperature probe assembly are configured to house and support the internal fitting in the thermowell.

These and other features and characteristics of the present invention, as well as the methods of operation and functions of the related elements of structures, and the combination of parts and economies of manufacture will become more apparent upon consideration of the following description and with reference to the accompanying drawings, all of which form a part of this specification, wherein like reference numerals designate corresponding parts in the various figures. It is to be expressly understood, however, that the drawings are for the purpose of illustration and description only, and are not intended as a definition of the limits of the invention. As used in the specification and the claims, the singular form of “a”, “an”, and “the” include plural referents unless the context clearly dictates otherwise.

### BRIEF DESCRIPTION OF THE DRAWINGS

FIG. 1 is a schematic view of an air-source heat pump system having a slide-in electronic temperature probe and thermowell in accordance with a prior art embodiment;

FIG. 2 is an enlarged view of the slide-in temperature electronic temperature probe and thermowell shown in FIG. 1;

FIG. 3 is a partially cut-away perspective view of a temperature probe assembly according to the principles of the present disclosure;

FIG. 4 is a view of an O-ring sealing member used in the assembly of FIG. 3;

FIG. 5 is a view of a snap ring used in the assembly of FIG. 3;

FIG. 6 is an exploded perspective view of the assembly of FIG. 3;

FIG. 7 is a side view of an internal fitting of the assembly of FIG. 3;

FIG. 8 is a cross-sectional view of the internal fitting taken along lines 8-8 shown in FIG. 7;

FIG. 9 is a front view of the internal fitting of the assembly of FIG. 3;

FIG. 10 is partial-sectional perspective view of the internal fitting taken along lines 10-10 shown in FIG. 9;

FIG. 11 is a cross-sectional perspective view of a temperature sensor and insulator of the assembly of FIG. 3 taken along lines 11-11 shown in FIG. 10 with the internal fitting removed for clarity;

FIG. 12 is a front view of another temperature probe assembly according to the principles of the present disclosure;

FIG. 13 is a cross-sectional view of the temperature probe assembly of FIG. 12 taken along lines 13-13 shown in FIG. 12;

FIG. 14 is a front view of an internal fitting of the assembly of FIG. 12;

FIG. 15 is a cross-sectional view of the internal fitting taken along lines 15-15 shown in FIG. 14; and

FIG. 16 is a cross-sectional view of a temperature sensor and insulator of the assembly of FIG. 12 taken along lines 16-16 shown in FIG. 15 with a portion of the internal fitting removed for clarity.

### DETAILED DESCRIPTION OF THE INVENTION

For purposes of the description hereinafter, special orientation terms, such as “end”, “upper”, “lower”, “right”, “left”, “vertical”, “horizontal”, “top”, “bottom”, “lateral”, “longitudinal”, and derivatives thereof, shall relate to the invention as it is oriented in the drawing figures. However, it is to be understood that the invention may assume various alternative variations and step sequences, except where expressly specified to the contrary. It is also to be understood that the specific devices and processes illustrated in the attached drawings, and described in the following specification, are simply exemplary embodiments or aspects of the invention. Hence, specific dimensions and other physical characteristics related to the embodiments or aspects disclosed herein are not to be considered as limiting.

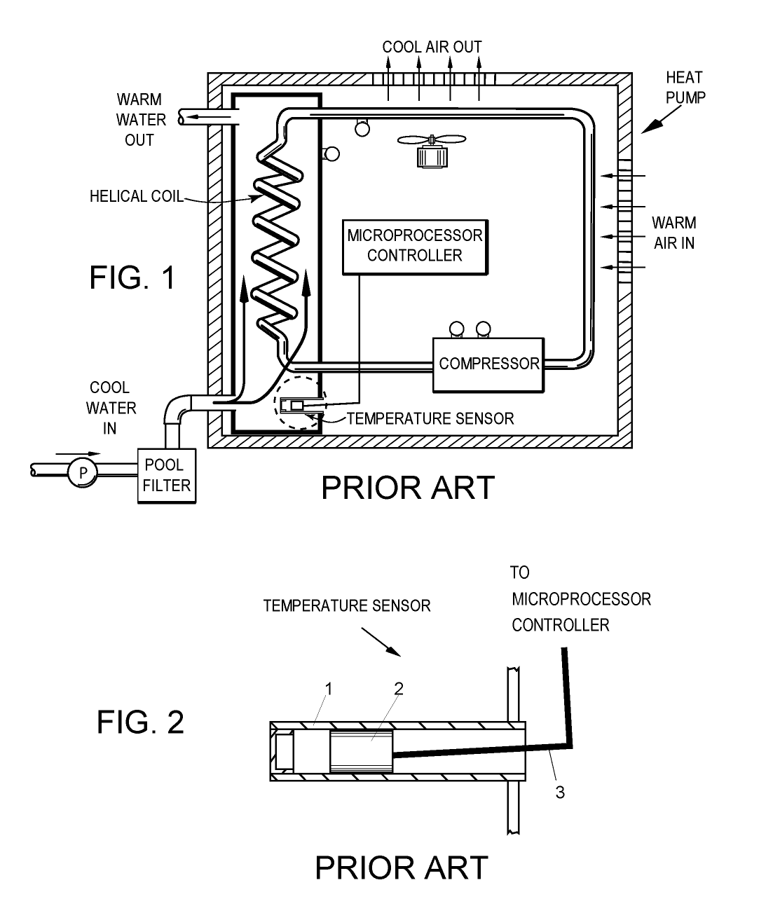

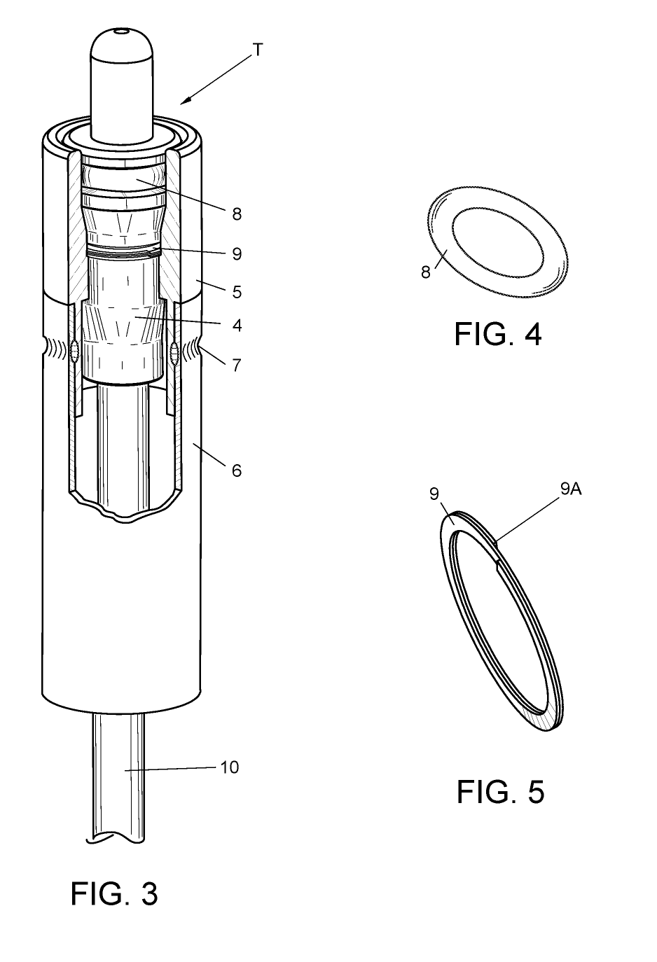

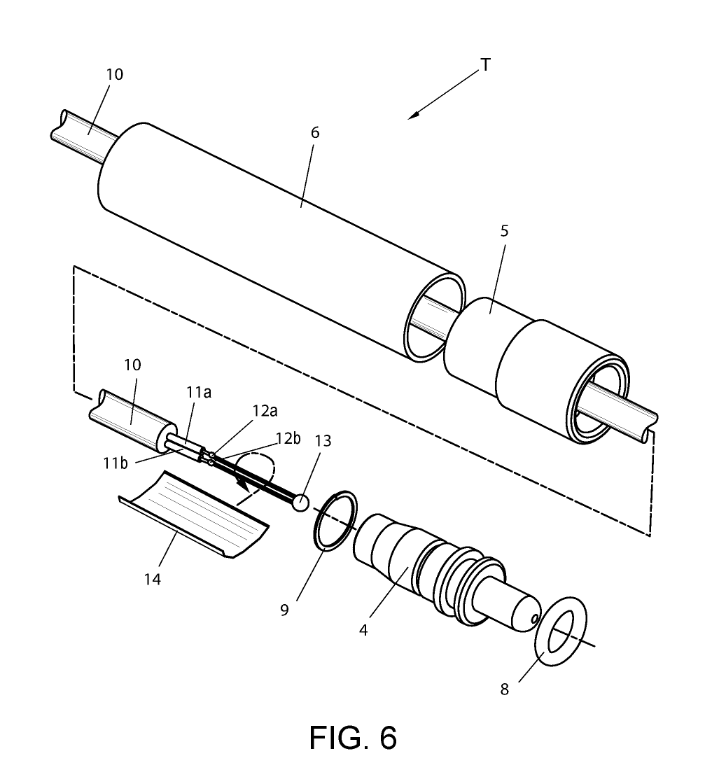

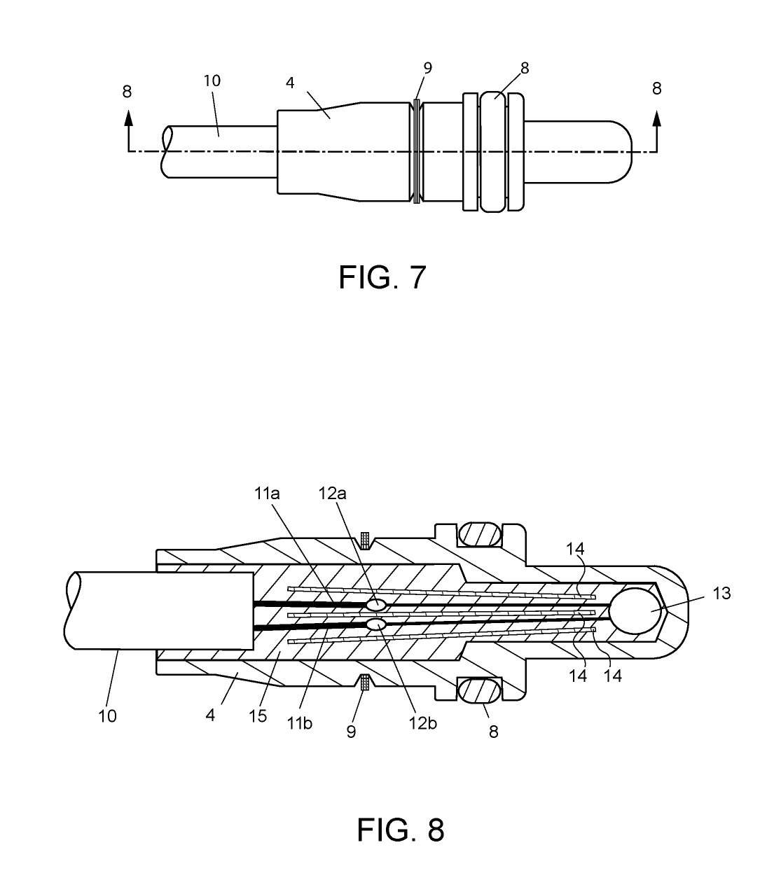

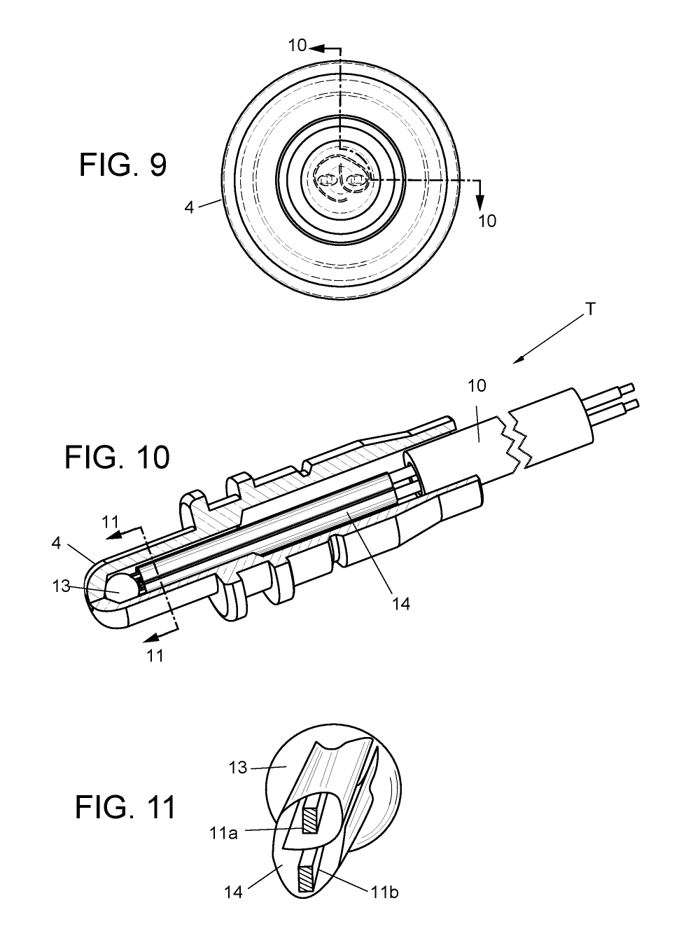

With reference to FIGS. 3-11, a temperature probe assembly T, according to a preferred and non-limiting embodiment or aspect of the present disclosure is shown. The temperature probe assembly T includes an internal or O-ring fitting 4 having an exterior and a hollow interior. As shown in FIGS. 6, 8, and 10, a temperature sensor is disposed within the hollow interior of the internal fitting 4. The temperature sensor is configured to be placed in communication with an external controller, such as the Microprocessor Controller shown in FIG. 1, for transmitting temperature readings from the temperature sensor to the Microprocessor Controller, which may control operation of a heat exchange system based upon the temperature measurements made by the temperature sensor. To that end, a cable 10 extends from the internal fitting 4. The cable 10 is connected to the temperature sensor, as will be discussed in further detail below. The cable 10 configured to place the temperature sensor in communication with the external controller. The temperature probe assembly T also includes an external or socket fitting 5 disposed on the exterior of the internal fitting 4 and a tube 6 connected to the external fitting 5. The internal fitting 4 is connected to the external fitting 5 by a fastening mechanism, as will be discussed in further detail below. The temperature probe assembly T is configured to be inserted into a thermowell, such as the thermowell 1 discussed above with reference to FIGS. 1 and 2. The tube 6 and the external fitting 5 are configured to house and support the internal fitting 4 in the thermowell 1. The tube 6 is configured to be further connected to the thermowell 1.

As shown in FIGS. 3 and 6-10, the fastening mechanism includes a snap-ring 9 disposed between the internal fitting 4 and the external fitting 5, which has a generally hollow, cylindrical shape and houses the internal fitting 4. The internal fitting 4 is generally cylindrical and includes a first notch or groove defined in the exterior near the rearward end of the internal fitting 4 for receiving the snap-ring 9 around the exterior of the internal fitting 4. The snap-ring 9 engages the notch or groove in the exterior of the internal fitting 4 and a corresponding groove defined on an interior surface of the external fitting 5. As shown in FIG. 5, the snap-ring 9 has a generally annular shape, with a tapered ramp 9A. When the internal fitting 4 is inserted completely into the external fitting 5, the snap-ring 9 expands and locks the internal fitting 4 and the external fitting 5 together by engaging the corresponding notches or grooves discussed above such that the internal fitting 4 and the external fitting 5 cannot be separated. The exterior of the internal fitting 4 defines a number of straight and tapered portions or sections that facilitate sliding of the snap-ring 9 onto the internal fitting 4. The diameter of the snap-ring 9 expands as it slides onto the internal fitting 4 and then contracts as it engages the first notch or groove of the internal fitting 4. Similarly, the snap-ring 9 contracts as the external fitting 5 is slid over the internal fitting 4 until the snap-ring 9 encounters the corresponding notch or groove formed in the interior surface of the external fitting 5, which allows the snap-ring 9 to expand to engage the notch or groove and connect the internal and external fittings 4, 5 such that they cannot be separated.

With reference to FIGS. 3 and 6-10, a sealing element, such as an O-ring 8, is disposed between the external fitting 5 and the internal fitting 4. The O-ring 8 is configured to at least partially seal an engagement between the internal fitting 4 and the external fitting 5. The O-ring 8 is disposed in a second notch or groove defined in the exterior of the internal fitting 4, which is formed near the forward end of the internal fitting 4 and is axially spaced from the first notch or groove along a longitudinal axis of the temperature probe assembly T. The external fitting 5 also includes a corresponding notch or groove in the interior surface for receiving the O-ring 8. As shown in FIG. 4, the O-ring 8 has a generally annular shape. The O-ring 8 prevents or inhibits fluid from leaking into the temperature probe assembly T.

With reference to FIGS. 6-11, the temperature sensor includes a thermistor 13 to detect temperature and at least two wires 11a, 11b. The thermistor 13 is disposed within the hollow interior of the internal fitting 4 adjacent to an end of the internal fitting 4. The thermistor 13 is connected to the at least two wires 11a, 11b via respective soldered portions 12a, 12b. The wires 11a, 11b connect the thermistor 13 to the cable 10 extending from the internal fitting 4. As shown in FIG. 6, the cable 10 extends from the internal fitting 4 through the exterior fitting 5 and the tube 6 to connect to the external controller and place the thermistor 13 in communication with the external controller. In order to prevent shorting or electrical conduction between the wires 11a, 11b and/or the soldered portions 12a, 12b, the at least two wires 11a, 11b are separated from each other and the interior of the internal fitting 4 by an insulator. As shown in FIGS. 6-11, the insulator includes a layer of insulative paper or tape 14 that is inserted between and wrapped around and between the at least two wires 11a, 11b so that the wires 11a, 11b do not touch each other or the internal fitting 4.

As shown in FIG. 8, the hollow interior of the internal fitting 4 is filled or potted with an epoxy material 15 injected into the internal fitting 4. As discussed above, the insulative paper or tape 14 separates the at least two wires 11a, 11b so that the wires 11a, 11b and the soldered portions 12a, 12b do not touch each other or the internal fitting 4 during injection of the epoxy material 15. The insulative paper or tape 14 also helps to minimize the volume of the epoxy material 15 to be injected into the internal fitting 4. According to one non-limiting embodiment or aspect of the present disclosure, the insulative paper or tape 14 has a thickness of between 0.002″ and 0.004″. More specifically, the insulative paper or tape 14 may have a thickness of between 0.002″ and 0.003″. Even more specifically, the insulative paper or tape 14 may have a thickness of 0.0025″. Alternatively, the insulative paper or tape 14 may have a thickness of 0.003″. According to one particular and non-limiting embodiment or aspect of the present disclosure, the insulative paper or tape 14 is a super-thin 0.0025″ thick, electrical tape made from polyester with an acrylic adhesive that is solvent resistant and has a thickness of 0.5″. It is to be appreciated that the insulative paper or tape 14 may be of any thickness or configuration known to be suitable to those having ordinary skill in the art and that the insulative paper or tape 14 may be replaced with a different insulator known to be suitable for the purposes discussed above.

As shown in FIG. 3, the tube 6 is connected to the external fitting 5 by welding. In particular, an orbital welded portion 7 is formed by welding to connect the tube 6 and the external fitting 5.

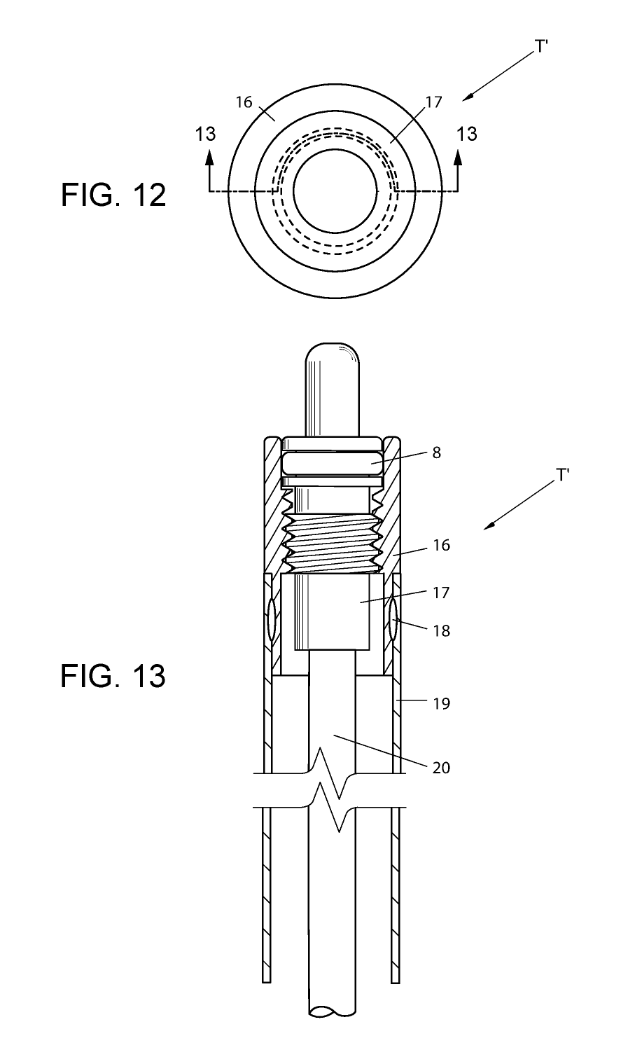

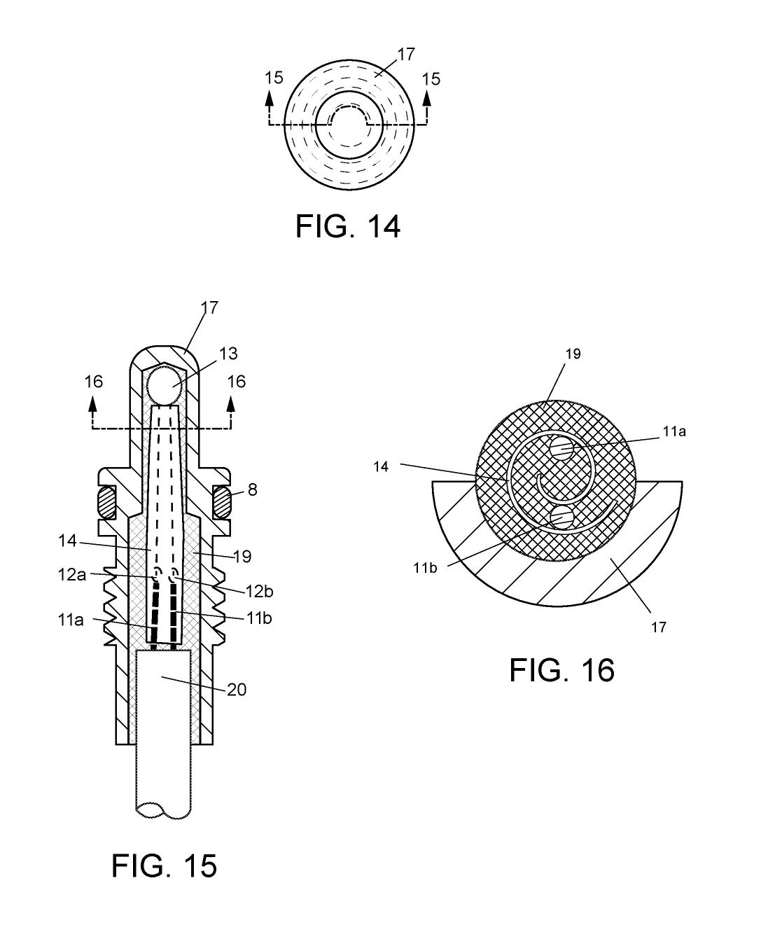

With reference to FIGS. 12-16, another temperature probe assembly T′ according to a preferred and non-limiting embodiment or aspect of the present disclosure is shown. The temperature probe assembly T′ includes a threaded internal or O-ring fitting 17 having an exterior and a hollow interior. As shown in FIGS. 15 and 16, a temperature sensor is disposed within the hollow interior of the internal fitting 17. The temperature sensor is configured to be placed in communication with an external controller, such as the Microprocessor Controller shown in FIG. 1, for transmitting temperature readings from the temperature sensor to the Microprocessor Controller. A cable 20 extends from the internal fitting 17 to place the temperature sensor in communication with the external controller. The temperature probe assembly T′ also includes a threaded external or socket fitting 16 disposed on the exterior of the internal fitting 17 and a tube 19 connected to the external fitting 16 by welding, which results in an orbital welded portion 18 being formed at the connection between external fitting 16 and the tube 19. The internal fitting 17 is connected to the external fitting 16 by a fastening mechanism that includes a threaded engagement between the threaded portions of the internal fitting 17 and the external fitting 16. The temperature probe assembly T′ is configured to be inserted into a thermowell, such as the thermowell 1 discussed above with reference to FIGS. 1 and 2. The tube 19 and the external fitting 16 are configured to house and support the internal fitting 17 in the thermowell 1. The tube 19 is further connected to the thermowell 1.

As discussed above, the external fitting 16 is connected to the internal fitting 17 by a threaded connection. The internal fitting 17 is generally cylindrical and includes a threaded portion defined in its exterior along a central portion of the internal fitting 17. The external fitting 16 has a generally hollow, cylindrical shape and houses the internal fitting 17. The external fitting 16 has a threaded portion defined in its interior surface that corresponds to the threaded portion defined on the internal fitting 17. According to one non-limiting embodiment or aspect of the present disclosure, the threads of the threaded internal fitting 17 have a pitch that is reduced to fit inside the threaded external fitting 16. The threads have a minor diameter large enough to fit around the assembly of the cable 20, the wires 11a, 11b, the thermistor 13, the layer of insulative paper or tape 14, and the epoxy material 15, and allow for the internal fitting 17 to have a sufficient wall thickness to maintain the structural integrity of the internal fitting 17. The specialized thread on the internal and external fittings 17, 16 can be programmed on a CNC machine once the major and minor diameters are determined. To this end, threads at the standard 60° angle are drawn between the two diameters such that they would intersect to make a full thread, allowing or standard thread fit radiuses and chamfers. The pitch of these special threads can be determined using geometry readily known to those having ordinary skill in the art. A CNC lathe can be programmed to make the threads of the internal fitting 17 and the mating threads of the external fitting 16.

As shown in FIG. 13, a sealing element, such as an O-ring 8, is disposed between the external fitting 16 and the internal fitting 17. The O-ring 8 is configured to at least partially seal an engagement between the internal fitting 17 and the external fitting 16. The O-ring 8 is disposed in a notch or groove defined in the exterior of the internal fitting 17, which is formed near the forward end of the internal fitting 17 and is axially spaced from the threaded portion along the longitudinal axis of the temperature probe assembly T′.

As shown in FIGS. 15 and 16, the temperature sensor includes a thermistor 13 and at least two wires 11a, 11b, which are the same as discussed above with reference to the embodiment of FIGS. 3-12. The thermistor 13 is connected to the at least two wires 11a, 11b by soldered portions 12a, 12b. The wires 11a, 11b connect the thermistor 13 to the cable 20 extending from the internal fitting 17 and through the exterior fitting 16 and the tube 19 to connect to the external controller and place the thermistor 13 in communication with the external controller.

As discussed above with reference to the embodiment of FIGS. 3-12, a layer of insulative paper or tape 14 is wrapped around and between the at least two wires 11a, 11b and the soldered portions 12a, 12b to separate the wires 11a, 11b from each other and from the interior surface of the internal fitting 17 to prevent shorting. As shown in FIGS. 15 and 16, the hollow interior of the internal fitting 17 is filled or potted with an epoxy material 15 injected into the internal fitting 17.

With reference to FIG. 13, the tube 19 and cable 20 are longer than the tube 6 and the cable 10 of the embodiment discussed above with reference to FIGS. 3-12. One of the advantages of having a longer tube 19 and cable 20 is the ability to easily replace the temperature probe assembly T′, especially where the length of the thermowell 1 is required to be substantial. For example, a swimming pool heat pump can have a well length of 22″. The combination of the threaded engagement between the internal fitting 17 and the external fitting 16 and the lengthened tube 19 and cable 20 allows for easy disassembly and replacement of the various components of the temperature probe assembly T′. This configuration is also more economical and cost-effective because only the damaged or defective part, i.e., the internal fitting 17 and temperature sensor or the external fitting 16 and tube 19, needs to be replaced.

According to one particular non-limiting embodiment or aspect of the present disclosure, commercially pure titanium or various titanium alloys are used to fabricate the above-discussed fittings 4, 5, 16, 17, and tubes 6, 19. Particularly, titanium and titanium alloys are used when it is expected that the temperature probe assembly T, T′ will be exposed to heated fluid. In practice, water used in swimming pools and spas has high chlorine content, low pH exposure, and a temperature of up to and over 104° F. Titanium can withstand such water or fluids without exhibiting corrosion damage. Alternatively, different materials with similar heat conduction properties, such as brass, stainless steel, and aluminum, can be used in the fittings 4, 5, 16, 17, and tubes 6, 19 installed in less stringent fluid handling environments, such as plain tap water or oil. It is to be appreciated that any material known to be suitable to those having ordinary skill in the art may be used to form the fittings 4, 5, 16, 17, and tubes 6, 19 of the above-discussed temperature probe assemblies T, T′.

Testing of prototype parts according to the various embodiments described herein shows a thermal response time of a few seconds, compared with several minutes or more in the current slide-in type thermowell probe. In addition, the amount of injected epoxy material 15 and its thermal mass are reduced by approximately 80%.

With reference to FIGS. 3-16, a method of assembling a temperature probe assembly T, T′ according to one particular non-limiting embodiment or aspect of the present disclosure includes providing an internal fitting 4, 17 having an exterior and a hollow interior, a temperature sensor configured to be placed in communication with an external controller, an external fitting 5, 16, and a tube 6, 19. The method further includes assembling the temperature sensor within the hollow interior of the internal fitting 4, 17; assembling the external fitting 5, 16 on the exterior of the internal fitting 4, 17; and connecting the tube 6, 19 to the external fitting 5, 16. The temperature probe assembly T, T′ is configured to be inserted into a thermowell, such as the thermowell 1 discussed above with reference to FIG. 1. The tube 6, 19 and the external fitting 5, 16 are configured to house and support the internal fitting 4, 17 in the thermowell 1. The step of assembling the external fitting 5, 16 on the exterior of the internal fitting 4, 17 includes connecting the external fitting 5, 16 to the internal fitting 4, 17 with a fastening mechanism.

The fastening mechanism may include a snap-ring 9 disposed between the internal fitting 4 and the external fitting 5 and the connecting step may include engaging the snap-ring 9 with a notch defined in the exterior of the internal fitting 4 and a corresponding groove defined on an interior surface of the external fitting 5.

Alternatively, the fastening mechanism may include a threaded engagement between the internal fitting 17 and the external fitting 16 and the connecting step may include threadably engaging the internal fitting 17 with the external fitting 16.

The method further includes at least partially sealing an engagement between the external fitting 5, 16 and the internal fitting 4, 17 with a sealing element 8 disposed between the external fitting 5, 16 and the internal fitting 4, 17.

The temperature sensor includes a thermistor 13 and at least two wires 11a, 11b and the step of assembling the temperature sensor within the hollow interior of the internal fitting 4, 17 includes disposing the thermistor 13 in the hollow interior of the internal fitting 4, 17 adjacent to an end of the internal fitting 4, 17; connecting the at least two wires 11a, 11b to a cable 10, 20 extending from the internal fitting 4, 17, the cable 10, 20 being configured to place the temperature sensor in communication with the external controller; and separating the at least two wires 11a, 11b from each other and the internal fitting 4, 17 with an insulator. The insulator includes a layer of insulative paper or tape 14 and the step of separating the at least two wires 11a, 11b includes wrapping the insulative paper or tape 14 around and between the at least two wires 11a, 11b. The method further includes filling the hollow interior of the internal fitting 4, 17 with an epoxy material 15.

With reference to FIGS. 3-16, a method of assembling a temperature probe assembly T, T′ in a thermowell, such as the thermowell 1 discussed above with reference to FIG. 1, according to one particular non-limiting embodiment or aspect of the present disclosure includes providing the temperature probe assembly T, T′. The temperature probe assembly T, T′ includes an internal fitting 4, 17 having an exterior and a hollow interior; a temperature sensor disposed within the hollow interior of the internal fitting 4, 17; an external fitting 5, 16 disposed on the exterior of the internal fitting 4, 17; and a tube 6, 19 connected to the external fitting 5, 16. The method further includes inserting the temperature probe assembly T, T′ into a thermowell 1 to position the temperature probe assembly T, T′ in the thermowell 1 to measure a temperature of a fluid in a container, such as heat exchange tank of the heat pump discussed above with reference to FIG. 1, in which the thermowell 1 is defined; and placing the temperature sensor in communication with an external controller, such as the Microprocessor Controller discussed above with reference to FIG. 1. The tube 6, 19 and the external fitting 5, 16 of the temperature probe assembly T, T′ are configured to house and support the internal fitting 4, 17 in the thermowell 1.

It is to be understood that the invention may assume various alternative variations and step sequences, except where expressly specified to the contrary. It is also to be understood that the specific devices and processes illustrated in the attached drawings, and described in the specification, are simply exemplary embodiments or aspects of the invention. Although the invention has been described in detail for the purpose of illustration based on what is currently considered to be the most practical and preferred embodiments or aspects, it is to be understood that such detail is solely for that purpose and that the invention is not limited to the disclosed embodiments or aspects, but, on the contrary, is intended to cover modifications and equivalent arrangements that are within the spirit and scope thereof. For example, it is to be understood that the present invention contemplates that, to the extent possible, one or more features of any embodiment or aspect can be combined with one or more features of any other embodiment or aspect.

The invention claimed is:

1. A temperature probe assembly, comprising:
an internal fitting having an exterior and a hollow interior;
a temperature sensor disposed within the hollow interior of the internal fitting, the temperature sensor being configured to be placed in communication with an external controller;
an external fitting disposed on the exterior of the internal fitting; and
a tube connected to the external fitting,
wherein the temperature probe assembly is configured to be inserted into a thermowell, the tube and external fitting being configured to house and support the internal fitting in the thermowell.

2. The temperature probe assembly according to claim 1, wherein the internal fitting is connected to the external fitting by a fastening mechanism.

3. The temperature probe assembly according to claim 2, wherein the fastening mechanism comprises a snap-ring disposed between the internal fitting and the external fitting, the snap-ring engaging a notch defined in the exterior of the internal fitting and a corresponding groove defined on an interior surface of the external fitting.

4. The temperature probe assembly according to claim 2, wherein the fastening mechanism comprises a threaded engagement between the internal fitting and the external fitting.

5. The temperature probe assembly according to claim 1, further comprising:
a sealing element disposed between the external fitting and the internal fitting and configured to at least partially seal an engagement between the internal fitting and the external fitting.

6. The temperature probe assembly according to claim 5, wherein the sealing element comprises an O-ring disposed in a notch defined in the exterior of the internal fitting.

7. The temperature probe assembly according to claim 1,
wherein the temperature sensor comprises a thermistor disposed within the hollow interior of the internal fitting adjacent to an end of the internal fitting and at least two wires,
wherein the at least two wires connect the thermistor to a cable extending from the internal fitting, the cable being configured to place the thermistor in communication with the external controller,
wherein the at least two wires are separated from each other and the internal fitting by an insulator.

8. The temperature probe assembly according to claim 7, wherein the insulator comprises a layer of insulative paper or tape.

9. The temperature probe assembly according to claim 8, wherein the layer of insulative paper or tape is wrapped around and between the at least two wires.

10. The temperature probe assembly according to claim 7, wherein the hollow interior of the internal fitting is filled with an epoxy material.

11. The temperature probe assembly according to claim 1, wherein the tube and the external fitting are connected by welding.

12. A method of assembling a temperature probe assembly, comprising:
providing an internal fitting having an exterior and a hollow interior, a temperature sensor configured to be placed in communication with an external controller, an external fitting, and a tube;
assembling the temperature sensor within the hollow interior of the internal fitting;
assembling the external fitting on the exterior of the internal fitting; and
connecting the tube to the external fitting,
wherein the temperature probe assembly is configured to be inserted into a thermowell, the tube and external fitting being configured to house and support the internal fitting in the thermowell.

13. The method according to claim 12, wherein the step of assembling the external fitting on the exterior of the internal fitting comprises connecting the external fitting to the internal fitting with a fastening mechanism.

14. The method according to claim 13, wherein the fastening mechanism comprises a snap-ring disposed between the internal fitting and the external fitting and the connecting step comprises engaging the snap-ring with a notch defined in the exterior of the internal fitting and a corresponding groove defined on an interior surface of the external fitting.

15. The method according to claim 13, wherein the fastening mechanism comprises a threaded engagement between the internal fitting and the external fitting and the connecting step comprises threadably engaging the internal fitting with the external fitting.

16. The method according to claim 12, further comprising at least partially sealing an engagement between the external fitting and the internal fitting with a sealing element disposed between the external fitting and the internal fitting.

17. The method according to claim 12,
wherein the temperature sensor comprises a thermistor and at least two wires and the step of assembling the temperature sensor within the hollow interior of the internal fitting comprises:
disposing the thermistor in the hollow interior of the internal fitting adjacent to an end of the internal fitting;
connecting the at least two wires to a cable extending from the internal fitting, the cable being configured to place the temperature sensor in communication with the external controller; and
separating the at least two wires from each other and the internal fitting with an insulator.

18. The method according to claim 17, wherein the insulator comprises a layer of insulative paper or tape and the step of separating the at least two wires comprises wrapping the insulative paper or tape around and between the at least two wires.

19. The method according to claim 18, further comprising filling the hollow interior of the internal fitting with an epoxy material.

20. A method of assembling a temperature probe assembly in a thermowell, comprising:
providing the temperature probe assembly, the temperature probe assembly comprising:
an internal fitting having an exterior and a hollow interior;
a temperature sensor disposed within the hollow interior of the internal fitting;
an external fitting disposed on the exterior of the internal fitting; and
a tube connected to the external fitting;
inserting the temperature probe assembly into a thermowell to position the temperature probe assembly in the thermowell to measure a temperature of a fluid in a container in which the thermowell is defined; and
placing the temperature sensor in communication with an external controller,
wherein the tube and external fitting of the temperature probe assembly are configured to house and support the internal fitting in the thermowell.
